(19) United States
(12) Patent Application Publication
(10) Pub. No.: US 2002/0105675 A1
(43) Pub. Date: Aug. 8, 2002

(54) Imaging system and imaging method

(75) Inventor: Takashi Toyofuku, Kanagawa (JP)

Correspondence Address: SUGHRUE, MION, ZINN, MACPEAK & SEAS, PLLC, 2100 Pennsylvania Avenue, N.W. Suite 800, Washington, DC, 20037-3213, US

(73) Assignee: FUJI PHOTO FILM CO., LTD.

(21) Appl. No.: 10/050,516

(22) Filed: Jan. 18, 2002

(30) Foreign Application Priority Data
Feb. 6, 2001 (JP) 2001-030162

(51) Int. Cl. G06F 15/00

(52) U.S. Cl. 358/1.15

(57) ABSTRACT

The present invention provides an imaging system in which even when an imaging device becomes inoperable, the entire system can still continue to be operated, and high reliability is obtained. When a second printer server receives a printing job from a first client personal computer, after preprocessing for output of print data, the second printer server transfers the printing job to a first printer, and an image data output operation is started in the first printer. When an error such as failure occurs during the image data output operation, a printer from which image data is outputted, is changed to a second printer of the same kind as the first printer. Preprocessing corresponding to the second printer is executed again. Thereafter, the printing job is transferred to the second printer, and the printing job is continuously executed by the second printer.

### BACKGROUND OF THE INVENTION

1. Field of the Invention

The present invention relates to an imaging system provided with a plurality of imaging devices for forming an image on a predetermined recording medium based on image information, an imaging indicating device which outputs, to the imaging devices, job information for imaging, and an imaging management device which executes an imaging job in the imaging devices based on the job information from the imaging indicating device are provided on the same network; and also to an imaging method by the imaging system.

1. Description of the Related Art:

Conventionally, in an imaging device in which an image is formed on a predetermined recording medium (for example, paper, film, photographic printing paper, printing plate or the like), a common personal computer serving as, for example, an imaging indicating device for indicating imaging, is generally connected to the imaging device, and an imaging operation is performed in accordance with job information indicating imaging, which information is sequentially transmitted from the personal computer. Various schemes for improving the productivity of the imaging operation have been proposed.

As an example of such imaging devices, Japanese Patent Application Laid-Open (JP-A) No. 2000-094806 discloses a printer which receives printing data, including paper designation information, from a superior host serving as an imaging indicating device and outputs the data as image data. In this technique, it is determined whether there is paper corresponding to paper designation information included in each printing data, and when printing data is sequentially received and printing is being performed, if recording paper corresponding to the paper designation information of preceding printing data is lacking, the printing order is changed and printing processing is performed for printing data for which recording paper corresponding to the paper designation information is supplied.

Further, JP-A No. 2000-141832 discloses an imaging device in which image data is received from a host device serving as an imaging indicating device, and stored and held therein for each job, and an image is thereby formed. With this technique, when a peculiar error occurs in a job that is forming an image, the job with the error is ended at once, and the next job is prepared.

In both of the above-described techniques, an operating environment utilizing a single imaging device is supposed. An example of imaging system using a plurality of imaging devices is a printing job processor disclosed in JP-A No. 2000-099292. A computer serving as an imaging indicating device, and a printer serving as an imaging device are connected, and another printer is also connected to the printer via a communication device. In this technique, the printer transmits and receives information as to whether there is printing paper, to and from the computer via the communication device, and when printing paper is lacking, a printing job is processed by another printer.

Although it is possible to prevent interruptions of imaging operations caused by a shortage of paper or an error in a job in all of the above-described conventional techniques, when the imaging device itself becomes inoperable due to internal failures and the equivalent, the system as a whole may become inoperable.

In order to solve the above-described problems, an imaging system has been conventionally known, wherein a plurality of printers are directly connected to one and the same network. However, in this imaging system, when one of the printers fails, a user needs to manually change a printer designated for outputting. Therefore, a productivity of this imaging system as a whole does not produce satisfactory results. Further, when printers for printing plates continuously form a plurality of plates for each printing processing are used, it is difficult to ensure a continuous operation by manually changing a printer when that printer has failed.

### SUMMARY OF THE INVENTION

The present invention has been achieved in order to solve the above-described problems. An object of the present invention is to provide an imaging system having high reliability, in which operation of the entire system can be continuously performed, and system failures can be avoided even when one of imaging devices becomes inoperable, and also provide an imaging method by the imaging system.

In accordance with one aspect of the present invention, there is provided a system for forming an image on a recording medium using a network, the system comprising: a plurality of imaging devices each in communication with the network and operable for forming an image on a recording medium based on image information received via the network; an imaging indicating device in communication with the network, the imaging indicating device outputting job information including at least image information and output device designation information via the network for designating a first imaging device included in the plurality of imaging devices; and a plurality of imaging management devices each in communication with the network and including program logic that performs steps comprising determining whether the first imaging device is in an operable state and if so, causing an imaging job for forming an image based on the image information is executed by the first imaging device, and when it is determined that the first imaging device is not operable, a second imaging device of the same kind as the first imaging device is selected from among the plurality of imaging devices and the imaging job is executed by the second imaging device, wherein the imaging devices, the imaging indicating device and the imaging management devices are connected by a network.

According to the present invention, the imaging indicating device outputs job information including at least image information and output device designation information for designating an imaging device. Further, the imaging management devices control so as to execute an imaging job for forming an image on a predetermined recording medium based on image information included in the job information by an imaging device which is designated by the output device designation information included in the job information from the imaging indicating device, and the imaging management devices constantly monitor the operating states of the respective imaging devices. Therefore, occurrence of abnormal states such as inoperable states can be detected for each of the imaging devices on the network. Accordingly, when one of the imaging devices in which the imaging job is being executed becomes inoperable, the imaging management devices select another imaging device of the same kind as the former imaging device and the imaging job can continue to be executed by the selected imaging device. Therefore, productivity can be improved. The same kind of imaging device means, for example, devices produced by the same manufacturer, devices of the same type, devices calibrated based on the same patch data, and the equivalent.

In the imaging system of the present invention, the imaging management devices determines whether the first imaging device is in an operable state during execution of the imaging job.

Usually, imaging devices of the same type, to say nothing of imaging devices of different types, each have individual calibration efficiencies, registration efficiencies, and the equivalent. Therefore, according to the present invention, by re-executing the imaging job which was interrupted from the beginning, proper output results can be obtained without being influenced by the differences in performance of each machine.

In the imaging system of the present invention, the imaging management devices store and hold performance information of the imaging devices. When it is determined that the first imaging device is not operable, the differences in performance between the first imaging device and the second imaging device is interpolated and the imaging job is executed by the second imaging device.

According to the present invention, the imaging management devices store and hold performance information of each imaging device, and mutually correct the differences in performance between the imaging devices by referring to respective performance information of the imaging devices. Therefore, even if an imaging device is changed during execution of the imaging job, the differences in performance between the imaging device before the change and the imaging device after the change can be reduced. As a result, when, for example, an image is outputted by color printing in which four color plates of cyan, magenta, yellow and black are formed as one set to thereby form an image, even if the imaging device is changed during the output operation, an output image for which calibration and registration is properly set can be obtained.

In accordance with another aspect of the present invention, there is provided an imaging system comprising: a plurality of imaging devices for forming, based on image information, an image on a predetermined recording medium; an imaging indicating device for outputting job information including at least image information and output device designation information for designating a first imaging device included among the imaging devices; a plurality of imaging management devices for controlling such that an imaging job for forming an image based on the image information is executed by the first imaging device; and a chief imaging management device for controlling such that a first imaging management device among the plurality of imaging management devices is judged, and when it is determined that the first imaging management device is operable, the job information is transmitted to the first imaging management device, and when it is determined that the first imaging management device is not operable, a second imaging management device of the same kind as the first imaging management device is selected from among the imaging management devices, and the job information is transmitted to the second imaging management device, wherein the imaging devices, the imaging indicating devices, the imaging management devices, and the chief imaging management device are connected together via a network.

According to the present invention, the imaging indicating device outputs job information including at least image information and output destination designation information for designating an imaging device. The imaging management devices each control so as to execute, with an imaging device which was designated by the output destination designation information included in the job information from the imaging indicating device, an imaging job for forming an image on a predetermined recording medium based on the image information included in the job information, and constantly monitor the operating state of each imaging device. The chief imaging management device transmits the job information outputted from the imaging indicating device, to the imaging management devices, and controls and constantly monitors respective operating states of the imaging management devices. Therefore, the chief imaging management device can detect the occurrence of an abnormal state such as an inoperable state for each of the imaging management devices on the network. As a result, when one of the imaging management devices is brought into an inoperable state, the chief imaging management device can select another imaging management device. The selected imaging management device selects, when one of the imaging devices in which the imaging job is being executed becomes inoperable, another imaging device of the same kind as the inoperable imaging device and the imaging job can continue to be executed by the selected imaging device. Accordingly, even when one of the imaging management devices becomes inoperable, the imaging job can continue to be executed by another imaging management device, thereby resulting in improvement of productivity.

In accordance with still another aspect of the present invention, there is provided an imaging method comprising the steps of: (a) outputting job information including at least image information and output device designation information for designating a first imaging device included in a plurality of imaging devices; (b) determining whether a first imaging management device among a plurality of imaging management devices is operable, and when the first imaging management device is operable, transmitting the job information to the first imaging management device, and when the first imaging management device is not operable, selecting a second imaging management device of the same kind as the first imaging management device from among the plurality of imaging management devices, and transmitting the job information to the second imaging management device; and (c) executing, based on the image information, an imaging job for forming an image with the imaging devices.

In accordance with still yet another aspect of the present invention, there is provided a system for printing an image via a network, the system comprising: (a) a plurality of printers comprising different types with some printers being of the same type, and each printer when in an operable state forming an image according to data received by the printer from the network; (b) a computer which outputs image and printer designation information to the network for printing an image in accordance therewith on a printer among the plurality of printers designated in the information; and (c) a printer server which receives the information output from the computer, the printer server including program logic that when executed performs steps including: (i) determining via the network whether the printer designated in the information received from the computer is in an operable state; (ii) choosing the designated printer for printing the image if the designated printer is in an operable state; (iii) if the designated printer is not in an operable state, determining via the network if another printer of the same type as the designated printer is in an operable state and if so, choosing the another printer for printing the image; and (iv) converting information received from the computer to image data in a format suitable for the chosen printer to print an image corresponding to the image information from the computer and outputting the data via the network to the chosen printer. dr

### BRIEF DESCRIPTION OF THE DRAWINGS

FIG. 1A is a schematic structural diagram of an imaging system according to a first embodiment of the present invention.

FIG. 1B is a diagram for illustrating the operation of the imaging system according to the first embodiment of the present invention.

FIG. 2 is a flow chart which shows the flow of a print control process according to the first embodiment of the present invention.

FIG. 3A is a schematic structural diagram of an imaging system according to a second embodiment of the present invention.

FIG. 3B is a diagram for illustrating the operation of the imaging system according to the second embodiment of the present invention.

FIG. 4 is a flow chart which shows the flow of a general printing control process according to the second embodiment of the present invention.

### DESCRIPTION OF THE PREFERRED EMBODIMENTS

Referring now to the attached drawings, embodiments of the present invention will be hereinafter described in detail.

[First Embodiment]

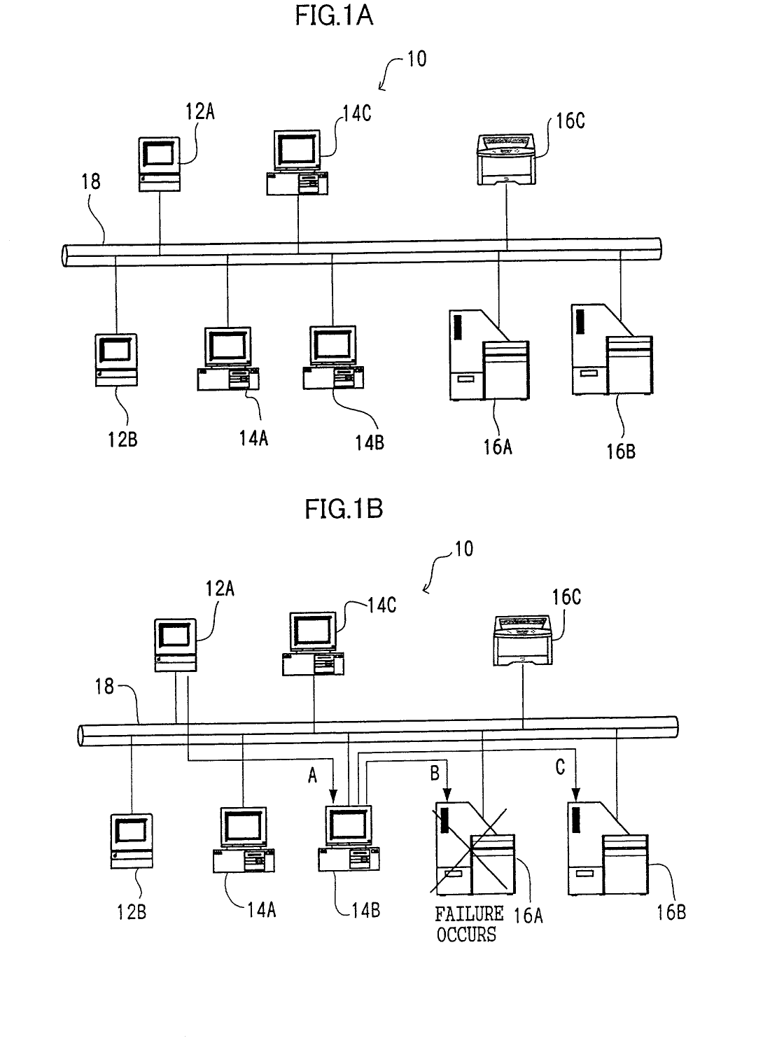

As illustrated in FIG. 1A, an imaging system 10 according to the first embodiment of the present invention is provided with: a first client personal computer 12A and a second client personal computer 12B, by which a user prepares image data and indicates so as to output the prepared image data; a first printer 16A, a second printer 16B and a third printer 16C, which each produce printout of the image data on a predetermined recording medium; and a first printer server 14A, a second printer server 14B and a third printer server 14C, which constantly monitor operating conditions of each of the three printers. These devices are connected with one another via a bus 18 so as to allow receiving and transmitting of various data therebetween, and the system as a whole forms a bus-type network.

The first client personal computer 12A and the second client personal computer 12B each output, by operations of a user, job information (printing job) including various setting information concerning an imaging operation, for example, the number of sheets to be outputted, paper size and the like, information which designates image data to be outputted and a printer to which the data is outputted, and the like.

The first printer 16A, the second printer 16B and the third printer 16C are each comprised of a color printer which allows printout of color images in addition to black-and-white images. At the time of outputting a color image, a color plate making process is performed, wherein a plate for each of the colors of cyan (C), magenta (M), yellow (Y) and black (K) is sequentially formed for image data to be outputted, and finally is positioned (registered) accurately and printed in an overlapping manner, therefore the printers execute a printing process to reproduce image data to be outputted. Further, the first printer 16A and the second printer 16B are the same type of printers, and the third printer 16C is a printer of a different kind from the other two printers. The recording medium used by the first printer 16A, the second printer 16B and the third printer 16C is not limited to printing plates such as PS plates, thermal plates or photopolymer plates, but any material such as paper, film or photographic printing paper can also be used as the recording medium so long as an image can be recorded thereon.

Further, the first printer server 14A, the second printer server 14B and the third printer server 14C each convert image data outputted from each of the client personal computers to a data format corresponding to a printer, and can transmit the converted imaging data to the printer. An example is a so-called rasterize process in which vector image data, which is output image data, is changed to bitmap image data corresponding to a resolution of each of the printers. Each of the printer servers includes information (device information) indicating the performance inherent in each of the devices concerning calibration and the like of each of the printers connected to the network, and performs the above-described rasterize processing based on the device information of a printer which is designated as a device to which data is outputted.

Next, the operation of the first embodiment will be described in detail. As an example, a case in which a user transmits, by the first client personal computer 12A, a printing job to the second printer server 14B and the first printer 16A outputs image data will be described.

When the user gives instruction for output of image data by the first client personal computer 12A, a printing job relating to output of the image data is transferred, via the bus 18, from the first client personal computer 12A to the second printer server 14B along the direction indicated by arrow A in FIG. 1B.

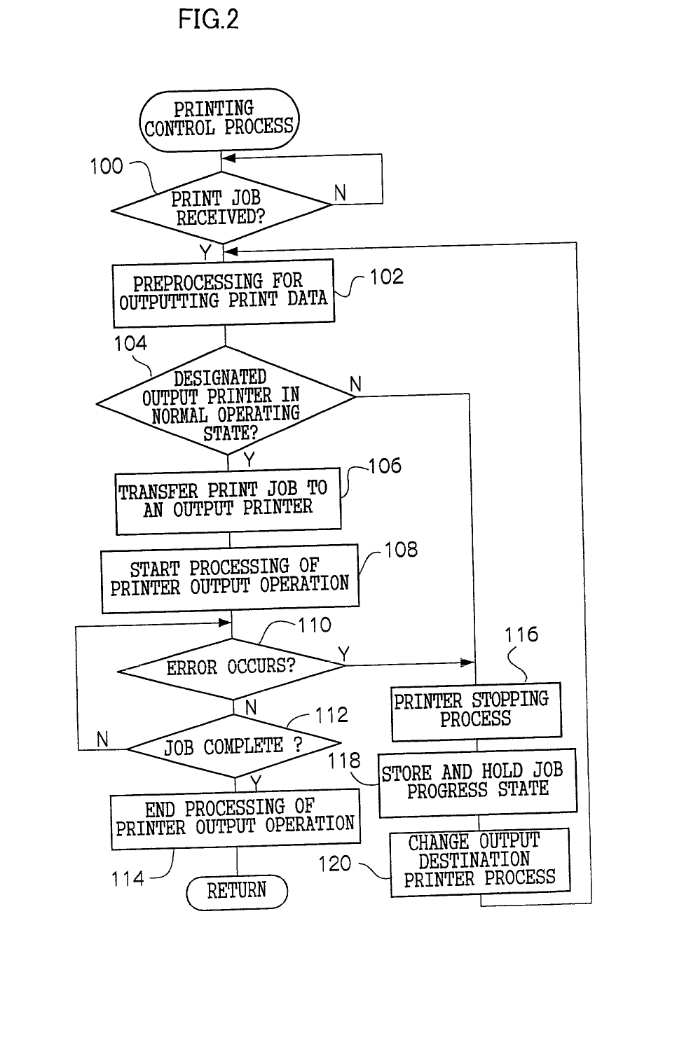

In each of the printer servers, a processing routine shown in FIG. 2 is executed.

The second printer server 14B is constantly in a state of waiting for receipt of a printing job outputted from each client personal computer. When the second printer server 14B receives the printing job outputted from the first client personal computer 12A, the process is judged affirmative at step 100. The process proceeds to step 102 in which preprocessing for output of print data is carried out. In this preprocessing, image data included in the printing job is, based on the resolution of the first printer to which image data is outputted, or calibration information, subjected to rasterize processing for conversion to bit map image data corresponding to the first printer.

In the subsequent step 104, it is determined whether the operating state of a printer designated as a printer to which image data is outputted (in this case, the first printer 16A) is normal.

When the operating state of the first printer 16A is normal, it is judged affirmative at step 104 and the process proceeds to step 106 in which the printing job is transferred to the first printer 16A (in this case, the printing job is transferred along the direction indicated by arrow B in FIG. 1B). Subsequently, the process proceeds to step 108 and an image data output operation is started by the first printer 16A in accordance with the printing job.

When no errors or failures occur during the image data output operation in the first printer 16A, the process is judged negative at step 110, and in step 112, it is determined whether the printing job has been completed.

When the determination of step 112 is made negative for the printing job that is being executed in the first printer 16A, the process returns to step 110 and the above-described processing is performed repeatedly. On the other hand, when the printing job has been completed by the first printer 16A, the determination of step 112 is affirmative and the process proceeds to step 114 in which the output operation of the first printer 16A ends and the processing routine also ends.

When the operating state of the first printer 16A is abnormal, the process is judged negative at step 104 and proceeds to step 116. Even when an error such as a failure occurs in the first printer 16A during the image data output operation, the process is judged affirmative at step 110 and proceeds to step 116.

In step 116, since abnormalities occur in the operating state of the first printer 16A, the operation of the first printer 16A is stopped.

In the subsequent step 118, the progress of the printing job in the first printer 16A is stored and held. The process proceeds to step 120 in which the output destination printer is changed to other printer of the same kind. In this case, the output destination printer is changed from the first printer 16A to, for example, the second printer 16B, which is the same kind of printer as the first printer 16A.

After the output destination printer is changed, the process returns to step 102 in which, if necessary, a printing job is subjected again to the above-described output preprocessing corresponding to the second printer 16B. Subsequently, the above-described processing is repeated. As a result, the second printer 16A is made the output destination printer and the printing job stored and held in the above-described step 118 is transferred along the direction indicated by arrow C in FIG. 1B and the printing job continues to be executed.

If the first printer 16A is restored during the output operation in the second printer 16B, changing the output destination printer back to the first printer 16A is also acceptable.

[Second Embodiment]

Next, a description will be given of the second embodiment of the present invention in detail.

An imaging system 10A according to the second embodiment is different from the imaging system 10 according to the above-described first embodiment in that an integrated management server 20 is added and connected to the bus 18. Other structures are the same as those of the imaging system 10 according to the first embodiment, and a description thereof will be omitted.

The integrated manager server 20 is provided so as to constantly monitor the operating state of each of the printer servers (that is, the first printer server 14A, the second printer server 14B and the third printer server 14C). Accordingly, the integrated manager server 20 can ascertain the respective operating states of the printer servers.

Next, the operation of the second embodiment will be described in detail. A case in which a user executes, by the first client personal computer 12A, a printing job in the first printer 16A via the second printer server 14B will be described as an example.

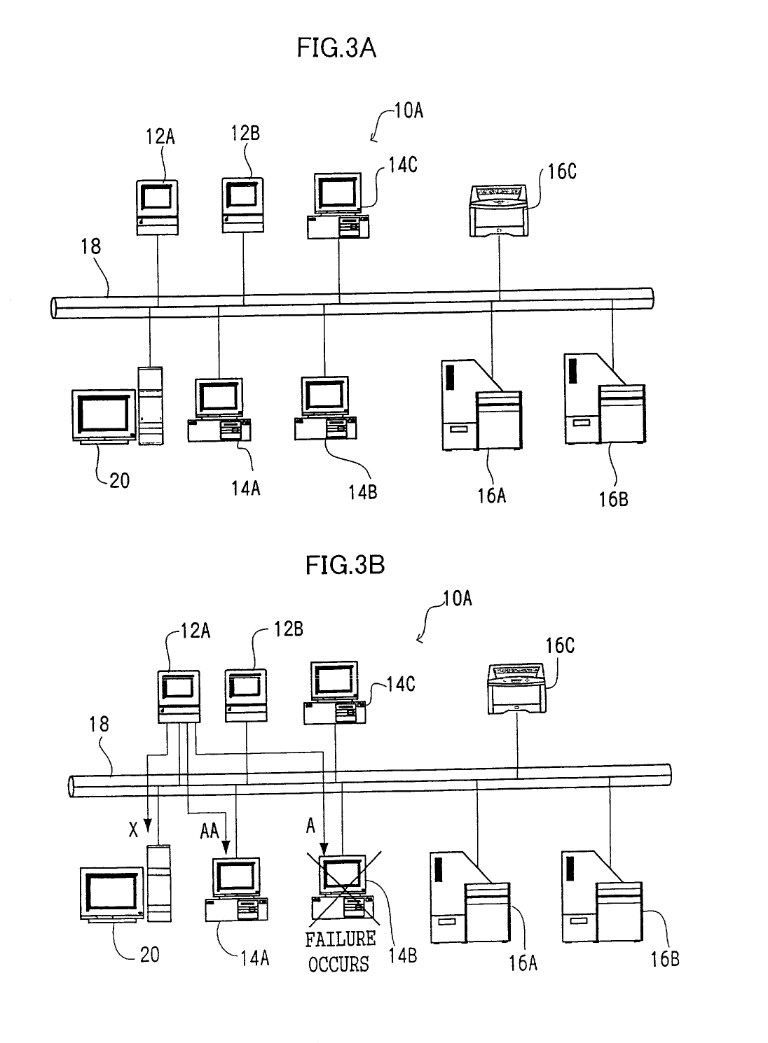

When, by the first client personal computer 12A, the user designates output of image data, printer server designation information for designating a printer server to be used is transferred from the first client personal computer 12A to the integrated management server 20 via the bus 18 along the direction indicated by arrow X in FIG. 3B.

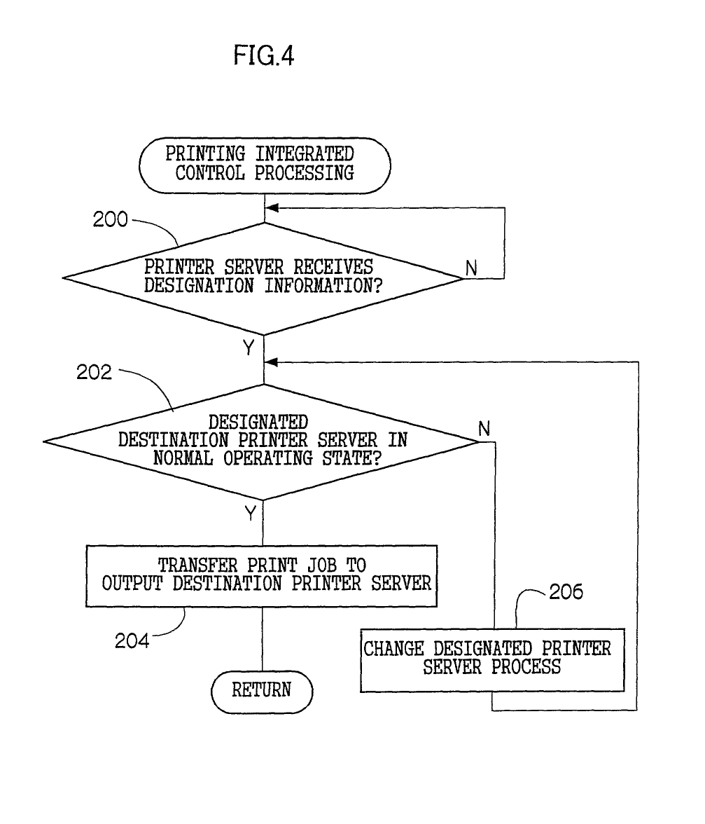

In the integrated management server 20, a processing routine shown in FIG. 4 is executed.

The integrated management server 20 is constantly in a state of waiting for receipt of the printer server designation information outputted from each of the client personal computers. When the integrated management server 20 receives the printer server designation information outputted from the first client personal computer 12A, the information is judged affirmative at step 200 and the process proceeds to step 202 in which it is determined whether the operating state of the designated printer server (in this case, the second printer server 14B) is normal.

When the operating state of the second printer server 14B is normal, the process is judged affirmative at step 202, and the process proceeds to step 204 in which the printing job is transferred to the second printer server 14B (in this case, the printing job is transferred along the direction indicated by arrow A in FIG. 3B) and the processing routine ends.

When the operating state of the second printer server 14B is abnormal, the process is judged negative at step 202 and proceeds to step 206 in which the designated printer server is changed to another printer server. In this case, for example, the designated printer server is changed from the second printer server 14B to the first printer server 14A.

After the designated printer server is changed, the process returns to step 202 in which the above-described processing is repeated. As a result, the designated printer server is changed to the first printer server 14A and the printing job is transferred to the first printer server 14A along the direction indicated by arrow AA in FIG. 3B.

When each printing job is transferred to the designated printer server, an imaging operation is carried out in the printer server in accordance with the processing routine shown in FIG. 4 in the same manner as in the imaging system 10 according to the first embodiment.

Further, the integrated management server 20 is constantly monitoring the operating state of each printer server. Therefore, even when an abnormality occurs in the operating state of the printer server during execution of the printing job, the integrated management server 20 detects the occurrence of abnormality and also changes to another printer server, which is in a normal operating state.

Thus, in the imaging system according to each of the above described embodiments, even when a failure occurs in one of devices on the network, a printing job which is being executed in the failed device can continue to be executed by being transferred to other device. As a result, productivity in the imaging operation can be improved.

As described above, according to the present invention, when an imaging device in which an imaging job is being executed, is brought into an inoperable state, another imaging device which is the same kind of the failed device is selected by an imaging management device, and the imaging job continues to be executed by the selected imaging device. Accordingly, an advantage is obtained by the present invention in that it is possible to provide an imaging system having high reliability in which, even when one of the imaging devices is brought into an inoperable state, the system as a whole can continue to be operated, and system failures can be prevented.

What is claimed is:

1. A system for forming an image on a recording medium using a network, the system comprising:
a plurality of imaging devices each in communication with the network and operable for forming an image on a recording medium based on image information received via the network;
an imaging indicating device in communication with the network, the imaging indicating device outputting job information including at least image information and output device designation information via the network for designating a first imaging device included in the plurality of imaging devices; and
a plurality of imaging management devices each in communication with the network and including program logic that performs steps comprising determining whether the first imaging device is in an operable state and if so, causing an imaging job for forming an image based on the image information is executed by the first imaging device, and when it is determined that the first imaging device is not operable, a second imaging device of the same kind as the first imaging device is selected from among the plurality of imaging devices and the imaging job is executed by the second imaging device,
wherein the imaging devices, the imaging indicating device and the imaging management devices are connected by a network.

2. The system according to claim 1, wherein the imaging management devices determine, before the imaging job is executed, whether the first imaging device is operable.

3. The system according to claim 2, wherein, during execution of the imaging job, the imaging management devices determines whether the first imaging device is operable.

4. The system according to claim 1, wherein the imaging management devices store and hold performance information of the imaging devices, and when it is determined that the first imaging device is not operable, the imaging management devices mutually correct a difference of performance between the first imaging device and the second imaging device, and execute the imaging job with the second imaging device.

5. The system according to claim 1, wherein, during execution of the imaging job by the second imaging device, the imaging management devices determine whether the first imaging device is operable, and when the first imaging device is operable, the imaging management devices control so that the imaging job is executed again by the first imaging device.

6. The system according to claim 5, wherein the imaging management devices store and hold performance information of the plurality of imaging devices, and when it has been determined that the first imaging device is operable, the imaging management devices interpolate the difference of performance between the first imaging device and the second imaging device, and the imaging job is executed by the first imaging device.

7. An imaging system comprising:
a plurality of imaging devices for forming, based on image information, an image on a predetermined recording medium;
an imaging indicating device for outputting job information including at least image information and output device designation information for designating a first imaging device included among the imaging devices;
a plurality of imaging management devices for controlling such that an imaging job for forming an image based on the image information is executed by the first imaging device; and
a chief imaging management device for controlling such that a first imaging management device among the plurality of imaging management devices is judged, and when it is determined that the first imaging management device is operable, the job information is transmitted to the first imaging management device, and when it is determined that the first imaging management device is not operable, a second imaging management device of the same kind as the first imaging management device is selected from among the imaging management devices, and the job information is transmitted to the second imaging management device,
wherein the imaging devices, the imaging indicating devices, the imaging management devices, and the chief imaging management device are connected together via a network.

8. The imaging system according to claim 7, wherein, prior to execution of the imaging job, the chief imaging management device determines whether the first imaging management device is operable.

9. The imaging system according to claim 8, wherein, during the execution of the imaging job, the chief imaging management device determines whether the first imaging management device is operable.

10. The imaging system according to claim 7, wherein the imaging management devices control so as to determine whether the first imaging device designated by the output device designation information is operable, and when the first imaging device is operable, an imaging job for forming an image based on the image information is executed by the first imaging device, and when the first imaging device is not operable, a second imaging device of the same kind as the first imaging device is selected from among the imaging devices, and the imaging job is executed by the second imaging device.

11. The imaging system according to claim 10, wherein the imaging management devices determine, prior to execution of the imaging job, whether the first imaging device designated by the output device designation information is operable.

12. The imaging system according to claim 11, wherein, during execution of the imaging job, the imaging management devices determine whether the first imaging device designated by the output device designation information is operable.

13. The imaging system according to claim 10, wherein the imaging management devices store and hold performance information of the imaging devices, and when it is determined that the first imaging device is not operable, the imaging management devices interpolate the difference of performance between the first imaging device and the second imaging device, and execute the imaging job with the second imaging device.

14. The imaging system according to claim 10, wherein, during execution of the imaging job by the second imaging device, the imaging management devices control so as to determine whether the first imaging device is operable, and when the first imaging device is operable, the imaging job is executed again by the first imaging device.

15. The imaging system according to claim 14, wherein the imaging management devices store and hold performance information among the imaging devices, and when it has been determined that the first imaging device is operable, the imaging management devices interpolate the difference of performance between the first imaging device and the second imaging device, and the imaging job is executed by the first imaging device.

16. An imaging method comprising the steps of:
(a) outputting job information including at least image information and output device designation information for designating a first imaging device included in a plurality of imaging devices;
(b) determining whether a first imaging management device among a plurality of imaging management devices is operable, and when the first imaging management device is operable, transmitting the job information to the first imaging management device, and when the first imaging management device is not operable, selecting a second imaging management device of the same kind as the first imaging management device from among the plurality of imaging management devices, and transmitting the job information to the second imaging management device; and
(c) executing, based on the image information, an imaging job for forming an image with the imaging devices.

17. The imaging method according to claim 16, wherein the step of determining whether a first imaging management device among a plurality of imaging management devices is operable, is performed prior to the step of executing, based on the image formation, an imaging job.

18. The imaging method according to claim 17, wherein the step of determining whether a first imaging management device among a plurality of imaging management devices is operable is performed during the step of executing, based on the image information, an imaging job.

19. The imaging method according to claim 16, wherein the step of executing, based on the image information, an imaging job includes determining whether the first imaging device is operable, and when the first imaging device is operable, executing the imaging job for forming an image based on the image information with the first imaging device, and when the first imaging device is not operable, selecting a second imaging device of a kind the same as the first imaging device from among the plurality of imaging devices and executing the imaging job with the second imaging device.

20. The imaging method according to claim 19, wherein when it has been determined that the first imaging device is not operable, the progress of the job or the first imaging device is determined and the second imaging device is used to complete execution of the job.

21. A system for printing an image via a network, the system comprising:
(a) a plurality of printers comprising different types with some printers being of the same type, and each printer when in an operable state forming an image according to data received by the printer from the network;
(b) a computer which outputs image and printer designation information to the network for printing an image in accordance therewith on a printer among the plurality of printers designated in the information; and
(c) a printer server which receives the information output from the computer, the printer server including program logic that when executed performs steps including:
(i) determining via the network whether the printer designated in the information received from the computer is in an operable state;
(ii) choosing the designated printer for printing the image if the designated printer is in an operable state;
(iii) if the designated printer is not in an operable state, determining via the network if another printer of the same type as the designated printer is in an operable state and if so, choosing the another printer for printing the image; and
(iv) converting information received from the computer to image data in a format suitable for the chosen printer to print an image corresponding to the image information from the computer and outputting the data via the network to the chosen printer.

22. The system according to claim 21, further comprising another printer server and a management server, the management server receiving via the network information output from the computer, wherein the information output from the computer includes printer server designation information, the management server including program logic that when executed performs steps comprising:
(a) determining via the network whether the printer server designated in the information received from the computer is in an operable state;
(b) choosing the designated printer server for receiving the information from the computer if the designated printer server is in an operable state;
(c) if the designated printer server is not in an operable state, determining via the network if another printer server is in an operable state and if so, choosing the another printer server; and
(d) passing control of the information received from the computer to the chosen printer server.
